(19) United States
(12) Patent Application Publication
(10) Pub. No.: US 2015/0142586 A1
(43) Pub. Date: May 21, 2015

(54) METHODS AND SYSTEMS FOR SYSTEMIZING A BRAND VOICE

(71) Applicant: R/GA, New York, NY (US)

(72) Inventor: Jeff Schulz, New York, NY (US)

(73) Assignee: R/GA

(21) Appl. No.: 14/308,500

(22) Filed: Jun. 18, 2014

Related U.S. Application Data
(60) Provisional application No. 61/836,553, filed on Jun. 18, 2013.

(51) Int. Cl. G06Q 30/02; G06F 17/27

(52) U.S. Cl. CPC G06Q 30/0276; G06F 17/274
USPC 705/14.73

(57) ABSTRACT

A computer-implemented method for systemizing a brand voice is disclosed. The computer implemented method includes the steps of defining a framework having one or more of writing styles, identifying one or more brand voice characteristics associated with each of the one or more writing styles, assigning an optimum quantitative value to each brand voice characteristic for each writing style based on one or more communication factors, and outputting the optimum quantitative value of each brand voice characteristic for a selected one or more writing styles. The method also includes the steps of receiving written material in a brand voice software application, analyzing the written material to determine a quantitative value for identified brand voice characteristics in the written material, comparing the determined quantitative value to a target quantitative value of the identified brand voice characteristics, altering the written material based on the comparison, and outputting the altered written material.

### CROSS REFERENCE TO RELATED APPLICATIONS

This application claims priority to U.S. Provisional Patent Application No. 61/836,553, filed Jun. 18, 2013, the entire content of which is hereby incorporated herein by reference.

### TECHNICAL FIELD

The present invention relates generally to systems and methods for systemizing a brand voice. More specifically, the present invention relates to systems and methods for associating writing styles with brand voice characteristics in order for business entities to use a variety of forms of communications to consistently, accurately, and/or effectively communicate with a variety of audiences.

### BACKGROUND OF THE INVENTION

Generally, business entities employ a variety of means for communicating with desired audiences as a mechanism for advertising and disseminating information. Traditionally, these communications occurred via television, radio, and/or print advertisements. With the advent of computers as a primary source of communication, today a business entity may choose to communicate via email, Short Messaging Services (SMS), Multimedia Messaging Services (MMS), in-store advertisements, marquee signs, and/or webpage banners. Each business entity desires that communications with its chosen audience via these mechanisms for advertising and disseminating information be effective.

Effective communications for each business entity are achieved via words and/or phrases used in their communications. Particularly, business entities are able to effectively communicate with their audiences when they are able to connect with their audiences using a distinct brand voice. A brand voice is a business entity's vehicle for emotionally connecting with its audiences via words and/or phrases. That is, a brand voice is a business entity's unique tone expressed via its written communications.

Each business entity's brand voice is shaped by brand voice characteristics that, when combined and expressed via words and/or phrases, enable audiences to connect with the business entity's message through various forms of communication. However, problems exist for business entities to consistently, accurately, and effectively use their brand voice across a variety of communications. Business entities have difficulties determining how to express the same brand voice characteristics in emails, SMS/MMS, in-store advertisements, marquee signs, and/or webpage banners, because each communication requires a different style of writing based on the number of words in the communication and the target audience. For example, business entities are able communicate longer messages to their audiences via emails than via a marquee sign or SMS/MMS.

There is, therefore, a need to employ a means for helping business entities to systemize their brand voice that is accessible and easy to use so that business entities will confidently know how to accurately, consistently, and effectively use their brand voice across a variety of communications.

### SUMMARY OF THE INVENTION

It is an object of the present invention to provide a method for systemizing a brand voice. In general, in one aspect, the present invention provides a computer-implemented method for systemizing a brand voice. The method may include the steps of defining a framework comprising one or more of writing styles, identifying one or more brand voice characteristics associated with each of the one or more writing styles, assigning an optimum quantitative value to each brand voice characteristic for each writing style based on one or more communication factors, and outputting the optimum quantitative value of each brand voice characteristic for a selected one or more writing styles.

Implementations of the invention may include one or more of the following features. The one or more writing styles may include one or more of expressive, promotional, instructional, and informational writing styles. The framework may include eight writing styles. The eight writing styles may include expressive, promotional, instructional, informational, expressive-promotional, promotional-instructional, informational-instructional, and expressive-informational writing styles. Assigning the optimum quantitative value may include assigning a quantitative value to each brand voice characteristic in a predetermined range. The predetermined range may be 0-10. Assigning the optimum quantitative value may include inputting one or more communication factors into a specifically programmed computer and using the specifically programmed computer to calculate the optimum quantitative value for each brand voice characteristic.

The framework may include at least two primary writing styles and at least one writing style sub-type. Assigning the optimum quantitative value may include assigning the optimum quantitative value to each brand voice characteristic for each primary writing style. The optimum quantitative value of the at least one writing style sub-type may be an interpolated value between the optimum quantitative value of each of the at least two primary writing styles. The one or more communication factors may include one or more of a business entity's characteristics, creative needs of a business entity, a form of communication, a purpose of the communication, and/or an audience of the communication.

In general, in another aspect, the present invention provides a computer-implemented method for systemizing a brand voice. The computer-implemented method may include receiving written material in a brand voice software application, analyzing the written material to determine a quantitative value for each of one or more identified brand voice characteristics in the written material, comparing the determined quantitative value of each of the one or more identified brand voice characteristics to a target quantitative value of each of the one or more identified brand voice characteristics, altering the written material based on the comparison, and outputting the altered written material.

Implementations of the invention may include one or more of the following features. Altering the written material may include revising the written material such that the quantitative value of each of the one or more identified brand voice characteristics matches the target quantitative value of each of the one or more identified brand voice characteristics.

### BRIEF DESCRIPTION OF THE DRAWINGS

The above-mentioned and other aspects, features and advantages can be more readily understood from the following detailed description with reference to the accompanying drawings, wherein:

FIG. 1 is a diagram of a writing style framework, according to an embodiment of the invention;

FIGS. 2(a)-(e) are diagrams of brand voice characteristics systemized into quantitative values, according to embodiments of the invention;

FIGS. 3(a)-(b) are diagrams of the optimum use of each brand characteristic for specific writing styles, according to an embodiment of the invention; and

FIG. 4 illustrates a method for guiding a business entity on how to articulate a desired brand voice, according to an embodiment of the invention.

FIG. 5 illustrates a method for systemizing a brand voice, according to an embodiment of the invention;

FIG. 6 illustrates a method for systemizing a brand voice, according to an embodiment of the invention.

### DETAILED DESCRIPTION OF THE PREFERRED EMBODIMENTS

The present invention provides for systems and methods for systemizing a brand voice. More specifically, the present invention provides systems and methods for helping business entities to consistently, accurately, and/or effectively communicate characteristics of their brand voice in a variety of communications. It should be noted that the present invention may be used by business entities that desire to communicate with a brand voice, but is not limited thereto. The present invention may be used in conjunction with any entity desiring effective communications with audiences using a variety of communications.

A brand voice may be a business entity's distinct tone used across all of its communications. The brand voice may be expressed via words and/or phrases in the business entity's communications. These communications may be any written and/or verbal communications known to those skilled in the art, including, but not limited to emails, flyers, SMS/MMS, in-store advertisements, marquee signs, and/or webpage banners. A business entity may choose a form of communication based on the goal or purpose of the communication and the desired audience.

Effective communications via the chosen form of communications may depend on the style of writing used in the communications. That is, different styles of writing are more effective in one form of communication than in another. In addition, the style of writing may depend on the goal or purpose of the communication. Accordingly, prior to determining the word and/or phrases to use in a chosen form of communication, a business entity may first want to select the most effective style of writing.

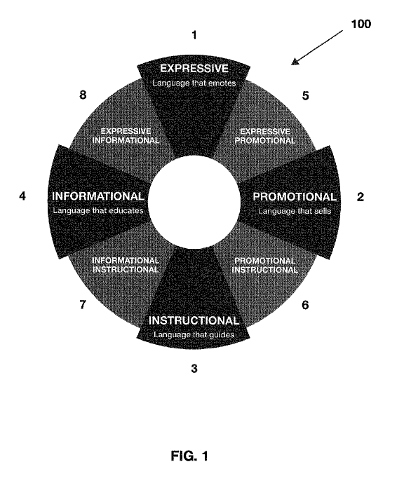

FIG. 1 illustrates a writing style framework 100 according to an embodiment of the invention. The writing style framework 100 may include one or more standardized writing styles that may be applied to all types of writing. The embodiment of FIG. 1 illustrates a writing style framework 100 that includes eight standardized styles of writing (described below). In alternative embodiments, the writing style framework 100 may include any desired number of standardized styles of writing known to those skilled in the art, so long as the standardized styles of writing may be configured to create effective forms of communication based on the purpose or goal of the communications to which they may be applied. For example, in the embodiment of FIG. 1, the eight standardized writing styles in the writing style framework 100 may be effective writing styles for business entities' communications.

FIG. 1 illustrates that the writing style framework 100 may include one or more primary writing styles 1-4. The one or more primary writing styles 1-4 may be one or more standardized writing styles that may be effective alone or in combination with one another in a variety of communications. For example, in the embodiment of FIG. 1, the one or more primary writing styles may be expressive 1, promotional 2, instructional 3, and informational 4. The one or more primary writing styles may be arranged in the writing style framework 100 in any desired order known to those skilled in the art. For example, as illustrated in FIG. 1, the one or more primary writing styles 1-4 may be arranged in the writing style framework 100 such that at least two of the primary writing styles 1-4 may be combined to create one or more writing style sub-types 5-8. In the embodiment of FIG. 1, the writing style sub-types 5-8 may be expressive-promotional 5, promotional-instructional 6, informational-instructional 7, and expressive-informational 8.

The writing style framework 100 may be used in combination with a business entity's brand voice characteristics in order to create effective communications. For example, when a business entity creates a communication, after one or more styles of writing are chosen, a business entity may determine how to use its brand voice characteristics in conjunction with the one or more styles of writing. In one embodiment, this determination may be accomplished by using a specifically programmed computer to systemize the brand voice characteristics into quantitative values.

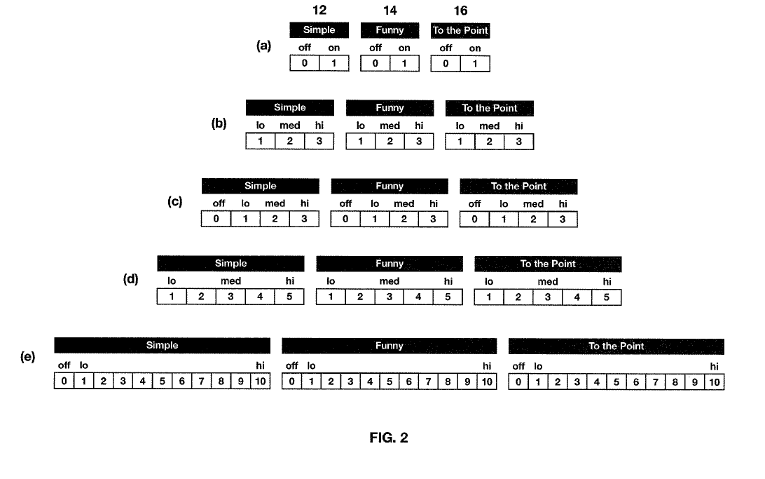

FIGS. 2(a)-(e) illustrate diagrams of brand voice characteristics systemized into quantitative values. The quantitative values may be any values configured to assist a business entity in determining how much of a brand voice characteristic to apply to a chosen writing style. That is, the quantitative value for a brand voice characteristic may be a target value representing the amount a business entity should express the brand voice characteristic in a particular communication. FIGS. 2(a)-(e) illustrate three examples of brand voice characteristics, simple, funny, and to the point. The present invention should not be limited to the type and/or number of brand voice characteristics illustrated in FIGS. 2(a)-(e). Alternative embodiments of the present invention may include any desired number and type of brand voice characteristics known to those skilled in the art and specific to particular business entities.

The embodiments of FIGS. 2(a)-(e) illustrate examples of quantitative values that may be applied to the brand characteristics. For example, in one embodiment (FIG. 2(a)), the quantitative values may be “on” and “off.” That is, for each brand voice characteristic, if the quantitative value is “1,” the brand voice characteristic may be expressed in words and/or phrases of a business entity's communication; and, if the quantitative value is “0,” the brand voice characteristic may not be expressed in the words and/or phrases of the business entity's communication. For example, FIG. 2(a) illustrates an example of three brand voice characteristics, “simple,” “funny,” and “to the point.” In an embodiment where the quantitative values may be, for example, 0, 1, and 1, respectively, the “simple” brand voice characteristic may not be expressed, while the “funny” and “to the point” brand voice characteristics may be expressed in the business entity's communication.

FIGS. 2(c) and 2(e) illustrate alternative embodiments of quantitative values for brand voice characteristics where the quantitative values range from “off” to “low” to “high.” Unlike the embodiment of FIG. 2(a), these embodiments may provide guidance for a business entity to determine the amount of expression of a brand voice characteristic in a particular communication. In these embodiments, a quantitative value greater than “0,” may range from low to high. A higher quantitative value for a brand voice characteristic may correlate to a greater amount of expression of the brand voice characteristic in a communication. For example, in an embodiment where the quantitative values for “simple,” “funny,” and “to the point” may be 8, 2, and 8, respectively, a communication may be created that may be very “simple,” not very “funny,” and very “to the point.”

The embodiments of FIGS. 2(b) and (d) illustrate examples of quantitative values for brand voice characteristics where the brand characteristics may always be “on.” In these embodiments, each brand voice characteristic may be expressed in each of the business entity's communications. However, the amount of the brand characteristic expressed in the communication may be dictated by a quantitative value in a range from “low” to “high.” The embodiments of FIGS. 2(b)-(e) illustrate quantitative values have ranges from 1-3, 0-3, 1-5, and 0-10. Embodiments of the invention are not limited to these ranges. The quantitative values for each brand characteristic may include any desired range of quantitative values known to those skilled in the art and may be chosen based on the particular business entity, the brand voice characteristics of the business entity, the desired communications from the business entity, and/or the creative needs of the business entity.

As previously discussed, the writing style framework 100 illustrated in FIG. 1 may be used in combination with a business entity's brand voice characteristics in order to create effective communications. More specifically, the quantitative value of each brand voice characteristic may be optimized in accordance with a particular writing style, such that a business entity may determine an amount of expression for each brand voice characteristic based on the writing style(s) used in a particular communication.

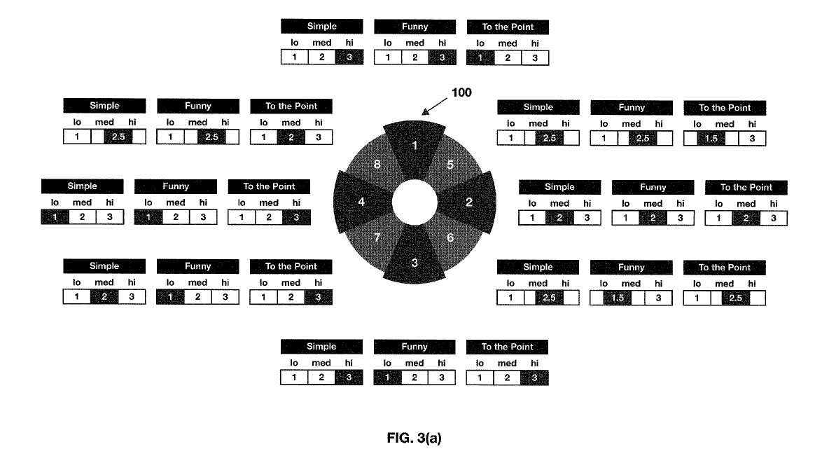

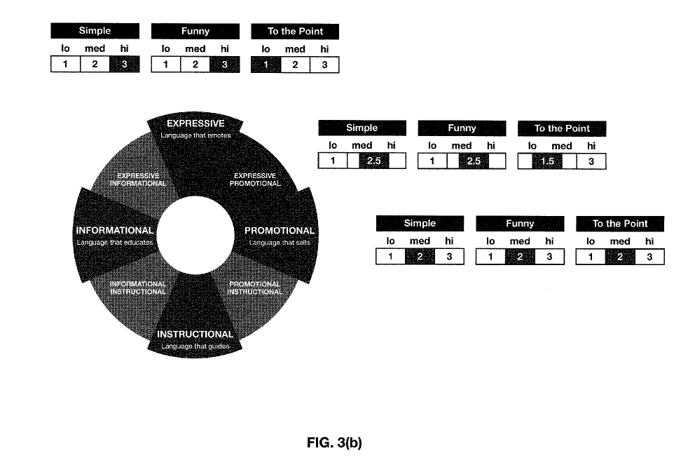

FIGS. 3(a)-(b) use the quantitative value embodiment illustrated in FIG. 2(b) to demonstrate an example of the optimum use of each brand characteristic for each standardized writing style illustrated in the writing style framework 100 of FIG. 1. The embodiment of FIGS. 3(a)-(b) is an example of the present invention and should not be limited to the illustrated range of quantitative values, the illustrated writing style, and/or the illustrated brand voice characteristics disclosed therein. As previously discussed, the range of quantitative values for each brand voice characteristic, the writing styles, and/or the brand voice characteristics may be any desired range, style, and/or characteristics known to those skilled in the art, which may be dependent on factors, including, but not limited to, the business entity and/or the form of communication.

As illustrated in FIG. 3(a), each brand voice characteristic may be systemized into a quantitative value for each writing style. The quantitative value may represent an optimum use of the brand voice characteristic for each writing style based on one or more customized formulae specific to a particular business entity. For example, the one or more customized formulae may be based on one or more communication factors, including, but not limited to, the business entity itself, the creative needs of the business entity, the brand voice characteristics of the business entity, the purpose or goal of business entity communications, and/or the intended audience(s) of the communications. In one embodiment, for example, a computer including one or more processors may be configured such that the quantitative value for each brand voice characteristic may be automatically generated using the one or more customized formulae based on one or more of the communication factors.

In some embodiments, the optimum quantitative value for each brand voice characteristic may first be calculated for each of the primary writing styles 1-4 on the writing style framework 100 based on the one or more customized formulae specific to the particular business entity. For example, in the embodiment FIG. 1, the optimum quantitative value for each brand voice characteristic may first be calculated for the “Expressive,” “Promotional,” “Instructional,” and “Informational” writing styles. Thereafter, the quantitative values for the primary writing styles 1-4 may be interpolated between the values of adjacent primary writing styles 1-4 on the writing style framework 100 to obtain an optimum quantitative value of each brand voice characteristic for each writing style sub-type 5-8. For example, as previously discussed, brand voice characteristics may include “simple,” “funny,” and “to the point.” FIGS. 3(a)-(b) illustrate an embodiment where the optimum quantitative values for the “Expressive” writing style may be 3 for “simple,” 3 for “funny,” and 1 for “too the point.” In addition, the embodiment of FIGS. 3(a)-(b) illustrate that the optimum quantitative values for the “Promotional” writing style (e.g., an adjacent writing style on the writing style framework 100) may be 2 for “simple,” 2 for “funny,” and 2 for “to the point. The optimum quantitative values of the “Expressive-Promotional” writing style may be calculated by interpolating the optimum quantitative values of the brand voice characteristics for the “Expressive” writing style and the “Promotional” writing style. As illustrated in FIGS. 3(a)-(b), the interpolated optimum quantitative values of “simple,” “funny,” and “to the point” may be 2.5, 2.5, and 1.5 respectively. To achieve this writing style, words and/or phrases must match these values.

In some embodiments, the interpolated optimum quantitative value for each writing style sub-type 5-8 may be calculated via one or more customized formulae based on one or more of the business entity communication factors previously discussed. Alternatively, or in addition, as illustrated in FIGS. 3(a)-(b), the interpolated optimum quantitative value for each writing style sub-type 5-8 may be an average of adjacent optimum quantitative values on the writing style framework 100.

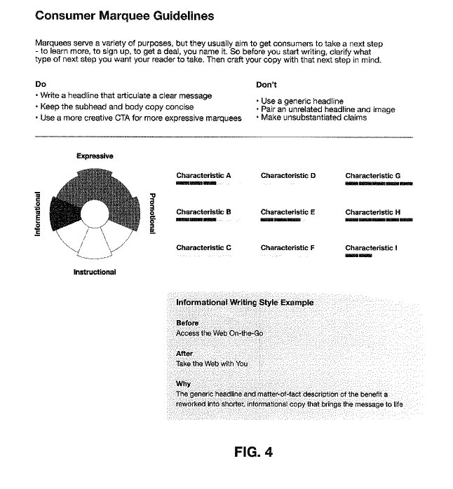

FIG. 4 illustrates a system and method for using the writing style framework 100 of FIG. 1 in combination with systemized quantitative values of each brand voice characteristic for each writing style to guide business entities on how to articulate a desired brand voice. In some embodiments, a business entity may input each of its brand voice characteristics and any other business entity communication factors into a brand voice software application. The brand voice application may be configured to calculate the optimum quantitative value of each brand voice characteristic for each writing style on the writing style framework 100 using one or more customized formulae for the business entity. Alternatively, a business entity may input its own target optimum quantitative values for each brand voice characteristic. A brand voice software application user may then choose one or more options, including, but not limited to, the type of communication (e.g., webpage banner, marquee sign, email, SMS/MMS, etc.), the audience for the communication (e.g., consumer, business entity employees, other business entities, etc.), and/or the writing style(s) for the communication. The brand voice software application may be configured to display an output of the optimum quantitative values for each brand voice characteristic based on the one or more chosen options and the particular business entity.

As illustrated in FIG. 4, the brand voice application may provide guidance to business entities by outputting the optimum quantitative values for each brand voice characteristic and/or by providing one or more examples of how to use to brand voice characteristics in combination with the identified writing style(s) to create a desired communication. In alternative embodiments, the brand voice application may enable a brand voice application user to input written material therein. The brand voice software application may be configured to determine a value for each brand voice characteristic in the inputted written material based on the chosen form of communication, writing style(s), and/or previously input business entity communication factors. The determined values may then be compared to the optimum quantitative value of each brand voice characteristic. The results of the comparison may be reported to the brand voice software application user, and the brand voice software application user may alter the inputted written material based on the reported results. Alternatively, the brand voice software application may be configured to automatically alter the inputted written material so that the optimum quantitative values are obtained. The revised written material may then be output to the brand voice software application user for use in conveying a brand voice or message.

The brand voice software application may be configured for use by business entities in any desired manner. For example, the brand voice software application may be used by business entities to determine the optimum quantitative values of brand voice characteristics to be used in desired communications based on one or more customized formulae and/or business entity communication factors. Alternatively, or in addition, the brand voice software application may be used as an in-house training tool for business entities. In those embodiments, after the optimum quantitative values of the brand voice characteristics for each writing style are determined, the brand voice software application may be programmed such that brand voice software application users may be able to choose the type of communication they are writing, the audience for the communication, and/or the writing style of the communication and may be provided with the optimum quantitative values for each brand voice characteristic. In this manner, a business entity may be able to provide direction to individuals within the business entity in order to obtain consistent, accurate, and/or effective brand voice expression in the business entity's internal and external communications.

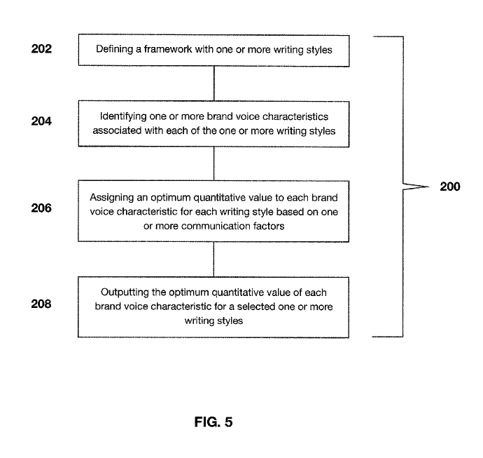

FIG. 5 illustrates a method for systemizing a brand voice 200 according to an embodiment of the invention. The method 200 may be performed on a specifically programmed computer via a brand voice software application. As illustrated in FIG. 5, the method may include the step of defining a framework with one or more writing styles 202. In one embodiment, the framework may be the writing style framework 100 illustrated in FIG. 1. In alternative embodiments, the framework may include any desired number and types of writing styles. The method 200 may further include identifying one or more brand voice characteristics associated with each of the one or more writing styles 204. This may be accomplished, for example, by identifying a business entity's brand voice characteristics. In one embodiment, as illustrated in FIGS. 2(a)-(e), the brand voice characteristics may be “simple,” “funny,” and/or “to the point.” Alternatively, or in addition, the brand voice characteristics may be any desired characteristics that a business entity may want to express via its distinct brand voice. Accordingly, the brand voice characteristics may be specific to each business entity.

FIG. 5 further illustrates that the method 200 may include assigning an optimum quantitative value to each brand voice characteristic for each writing style based on one or more communication factors 206. The one or more communication factors may be any factors that affect a business entity's communications, including, but not limited to, one or more of a business entity's characteristics (e.g., the type of business entity, products and/or services sold by the business entity, values of the business entity, business entity goals, etc.), the creative needs of a business entity, the form of communication, the purpose of the communication, and/or the audience of the communication. FIGS. 2(a)-(e) and FIGS. 3(a)-(b) illustrate that the optimum quantitative value for each brand characteristic may be specific to a specific writing style in the writing style framework 100. For example, as illustrated in FIG. 3(a), “simple” may have an optimum quantitative value of 3 for the “Expressive” writing style, but may have an optimum quantitative value of 2 for the “Promotional” writing style.

After the optimum quantitative values are assigned to each brand voice characteristic for each writing style, the method 200 may include outputting the optimum quantitative value of each brand voice characteristic for a selected one or more writing styles 208. For example, a brand voice software application user may select a writing style for which brand voice characteristic information may be desired. As illustrated in FIG. 4, if the brand voice software application user selects “Informational,” the brand voice software application may be configured to display the optimum quantitative value of each brand voice characteristic that corresponds to the “Informational” writing style.

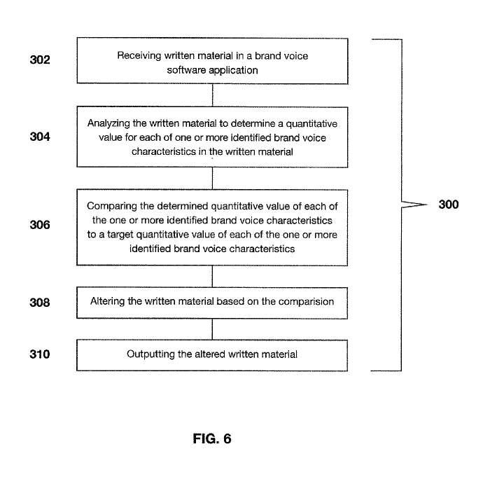

FIG. 6 illustrates another method of systemizing a brand voice 300, according to an embodiment of the invention. The method 300 may include receiving written material in a brand voice software application 302. The written material may be any material related to a communication which a brand software application user may intend to distribute to a desired audience. The brand voice software application may receive the written material using one or more processors. The method 300 may further include analyzing the written material to determine a quantitative value for each of one or more identified brand voice characteristics in the written material 304. As previously discussed, the brand voice characteristics may be any characteristics known to those skilled in the art and specific to a business entity. For example, in one embodiment, the brand voice characteristics may be “simple,” “funny,” and/or “to the point.” The analysis of the written material may include using the brand voice software application to determine the amount that each brand voice characteristic is expressed in the written material. In some embodiments, the brand voice characteristics in the written material may be identified by the brand voice software application user. Alternatively, the brand voice software application may be configured to identify the brand voice characteristics in the written material.

FIG. 6 illustrates that after the written material is analyzed, the brand voice application software may be configured to compare the determined quantitative value of each of the one or more identified brand voice characteristics to a target quantitative value of each of the one or more identified brand voice characteristics 306. In some embodiments, the target quantitative value of each of the one or more identified brand voice characteristics may be determined via the method 200 of FIG. 5. Alternatively, the target quantitative value of each of the one or more identified brand voice characteristics may be provided to the brand voice software application by the brand voice software application user.

The method 300 may further include altering the written material based on the comparison 308. For example, the brand voice software application may be configured to revise the written material such that the quantitative value of each of the one or more identified brand voice characteristics matches the target quantitative value of each of the one or more identified brand voice characteristics. Alternatively, or in addition, the brand voice software application may suggest alternate wording so that the target values may be reached or satisfied. The brand voice software application may then be configured to output the altered written material 310.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. The objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

What is claimed:

1. A computer-implemented method for systemizing a brand voice, comprising:
defining a framework comprising one or more writing styles;
identifying one or more brand voice characteristics associated with each of the one or more writing styles;
assigning an optimum quantitative value to each brand voice characteristic for each writing style based on one or more communication factors; and
outputting the optimum quantitative value of each brand voice characteristic for a selected one or more writing styles.

2. The computer-implemented method of claim 1, wherein the one or more writing styles comprise one or more of expressive, promotional, instructional, and informational writing styles.

3. The computer-implemented method of claim 1, wherein the framework comprises eight writing styles.

4. The computer-implemented method of claim 3, wherein the eight writing styles comprise expressive, promotional, instructional, informational, expressive-promotional, promotional-instructional, informational-instructional, and expressive-informational writing styles.

5. The computer-implemented method of claim 1, wherein assigning the optimum quantitative value comprises assigning a quantitative value to each brand voice characteristic in a predetermined range.

6. The computer-implemented method of claim 5, wherein the predetermined range is 0-10.

7. The computer-implemented method of claim 1, wherein assigning the optimum quantitative value comprises inputting one or more communication factors into a specifically programmed computer and using the specifically programmed computer to calculate the optimum quantitative value for each brand voice characteristic.

8. The computer-implemented method of claim 1, wherein the framework includes at least two primary writing styles and at least one writing style sub-type.

9. The computer-implemented method of claim 8, wherein assigning the optimum quantitative value comprises assigning the optimum quantitative value to each brand voice characteristic for each primary writing style.

10. The computer-implemented method of claim 9, wherein the optimum quantitative value of the at least one writing style sub-type is an interpolated value between the optimum quantitative value of each of the at least two primary writing styles.

11. The computer-implemented method of claim 1, wherein the one or more communication factors include one or more of a business entity's characteristics, creative needs of a business entity, a form of communication, a purpose of the communication, and/or an audience of the communication.

12. A computer-implemented method for systemizing a brand voice, comprising:
receiving written material in a brand voice software application;
analyzing the written material to determine a quantitative value for each of one or more identified brand voice characteristics in the written material;
comparing the determined quantitative value of each of the one or more identified brand voice characteristics to a target quantitative value of each of the one or more identified brand voice characteristics;
altering the written material based on the comparison; and
outputting the altered written material.

13. The computer-implemented method of claim 13, wherein altering the input written material comprises revising the written material such that the quantitative value of each of the one or more identified brand voice characteristics in the written material matches the target quantitative value of each of the one or more identified brand voice characteristics.
